(19) United States
(12) Patent Application Publication
(10) Pub. No.: US 2025/0326683 A1
(43) Pub. Date: Oct. 23, 2025

(54) LITHIUM DISILICATE GLASS-CERAMICS

(71) Applicant: James R. Glidewell Dental Ceramics, Inc., Newport Beach, CA (US)

(72) Inventors: Hrishikesh Kamat, Foothill Ranch, CA (US); Lynh Tran, Tustin, CA (US); Fernando Vivar, Tustin, CA (US); Sreeram Balasubramanian, Irvine, CA (US)

(73) Assignee: James R. Glidewell Dental Ceramics, Inc., Newport Beach, CA (US)

(21) Appl. No.: 19/176,969

(22) Filed: Apr. 11, 2025

Related U.S. Application Data
(60) Provisional application No. 63/635,455, filed on Apr. 17, 2024.

(51) Int. Cl. C03C 10/00; A61C 13/00; C03C 4/00

(52) U.S. Cl. CPC C03C 10/00; A61C 13/0022; C03C 4/0021; C03C 2204/00

(57) ABSTRACT

In one example, a lithium disilicate glass-ceramic produced from a composition comprising SiO₂, Li₂O, Al₂O₃, K₂O, P₂O₅, Na₂O, ZrO₂, and TiO₂, wherein Na₂O, ZrO₂, and TiO₂ are present in the composition in an amount such that Na₂O/(TiO₂+ZrO₂) (wt. %/wt. %) is between 0.5 and 1.25. In another example, a lithium disilicate glass-ceramic produced from a composition comprising SiO₂, Li₂O, Al₂O₃, K₂O, P₂O₅, Na₂O, ZrO₂, and TiO₂, wherein TiO₂, ZrO₂, SiO₂ and Li₂O are present in the composition in an amount such that ((TiO₂+ZrO₂)/(TiO₂+ZrO₂+SiO₂+Li₂O))×100 (wt. %/wt. %) is between 3.5 and 4.

This application claims the benefit of and priority to U.S. Provisional Patent Application No. 63/635,455, filed Apr. 17, 2024, which is incorporated herein by reference in its entirety.

### BACKGROUND

Lithium disilicate glass-ceramics have gained prominence as dental grade materials owing to their high strength, excellent aesthetics, and ability to be formed into dental restorations using standard processing techniques including computer-assisted design/computer-assisted manufacturing (CAD/CAM) milling. However, owing to the poor machinability of the lithium disilicate (Li₂Si₂O₅) phase, these materials have to be milled in their precursor lithium metasilicate (Li₂SiO₃) phase, which is softer and weaker than Li₂Si₂O₅, and then transformed to the Li₂Si₂O₅ phase by a controlled heat treatment step. The heating step not only adds processing time, but also causes material deformation.

### SUMMARY

Disclosed herein is a lithium disilicate glass-ceramic produced from a composition comprising SiO₂, Li₂O, Al₂O₃, K₂O, P₂O₅, Na₂O, ZrO₂, and TiO₂, wherein Na₂O, ZrO₂, and TiO₂ are present in the composition in an amount such that Na₂O/(TiO₂+ZrO₂) (wt. %/wt. %) is between 0.5 and 1.25.

Also disclosed herein is a lithium disilicate glass-ceramic produced from a composition comprising SiO₂, Li₂O, Al₂O₃, K₂O, P₂O₅, Na₂O, ZrO₂, and TiO₂, wherein TiO₂, ZrO₂, SiO₂ and Li₂O are present in the composition in an amount such that ((TiO₂+ZrO₂)/(TiO₂+ZrO₂+SiO₂+Li₂O))×100 (wt. %/wt. %) is between 3.5 and 4.

Further disclosed herein is a glass-ceramic comprising 70 to 85 vol. % of a lithium disilicate (Li₂Si₂O₅) crystalline phase, 5 to 20 vol. % of a lithium metasilicate (Li₂SiO₃) crystalline phase, and 2 to 18 vol. % of a lithophosphate (Li₃PO₃) crystalline phase, with the percentages being expressed as a portion of the total crystalline phase.

Additionally disclosed herein is a dental milling blank comprising a glass-ceramic as described herein.

Also disclosed herein is a method for making a dental milling blank, comprising:
mixing initial ingredients, wherein the initial ingredients comprise SiO₂, Li₂CO₃, Al(OH)₃, K₂CO₃, Al(PO₃)₃, Na₂CO₃, ZrO₂, and TiO₂;
calcining the mixture to convert Li₂CO₃ to Li₂O, K₂CO₃ to K₂O, Na₂CO₃ to Na₂O, Al(OH)₃ to Al₂O₃, and Al(PO₃)₃ to Al₂O₃ and P₂O₅ thereby producing a calcined intermediate;
heating the calcined intermediate;
quenching the heated calcined intermediate thereby producing a quenched intermediate; and
crystallizing the quenched intermediate.

The foregoing will become more apparent from the following detailed description, which proceeds with reference to the accompanying figures.

### BRIEF DESCRIPTION OF THE DRAWINGS

FIG. 1 is a chart showing comparative prior art and illustrative inventive glass-ceramic compositions. The amounts shown are in weight percent, based on the total weight of the composition.

FIG. 2 is an illustrative X-ray diffraction pattern of an inventive glass-ceramic composition.

### DETAILED DESCRIPTION

As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

### Overview

Disclosed herein is a high strength dental milling blank containing lithium disilicate as the main crystalline phase, which can be milled into a dental prosthesis without significant chipping. The milled dental prosthesis does not require an additional heat treatment step post-milling to achieve its final mechanical and optical properties. The lithium disilicate glass-ceramic can be milled in its fully crystallized state. As used herein, “fully crystallized state” refers to a glass-ceramic in which a major portion (around 50-80%) of the material's volume is occupied by the total crystalline components (e.g. the combined presence of Li₂Si₂O₅, Li₂SiO₃, and Li₃PO₃). The remaining portion of the material comprises the amorphous glass phase. Furthermore, the major crystalline phase of the total crystalline components is lithium disilicate (Li₂Si₂O₅).

In certain examples, Li₂Si₂O₅ is the major phase (i.e., greater than 50%) and Li₂SiO₃ and Li₃PO₄ are the secondary phase present in the fully crystallized milling blank.

The dental milling blank is a glass-ceramic produced from a composition that includes SiO₂, Li₂O, Al₂O₃, K₂O, P₂O₅, Na₂O, ZrO₂, and TiO₂. In certain examples, the mixture also includes at least one of CeO₂, V₂O₅, Er₂O₃, Pr₂O₃, SnO₂, MnO₂, and F₂.

In certain examples, the composition does not include an alkaline earth metal. In certain examples, the composition include 65 to 71, or 67 to 71, or 67.5 to 70.5, wt. % SiO₂; 12.5 to 14.75, or 13 to 14.75, or 14 to 14.6, wt. % Li₂O; 2.80 to 3.40, or 3.0 to 3.40, or 3.20 to 3.40, wt. % Al₂O₃; 2.75 to 3.10, or 2.85 to 3.10, or 2.95 to 3.10, wt. % K₂O; 2.80 to 3.20, or 2.95 to 3.20, or 3.05 to 3.20, wt. % P₂O₅; 1.50 to 3.50, or 1.50 to 3.0, or 2.0 to 2.85 wt. % Na₂O; 1.5 to 2.5, or 1.8 to 2.5, or 1.9 to 2.0, wt % ZrO₂; and 1.2 to 1.5, or 1.2 to 1.4, or 1.2 to 1.3, wt. % TiO₂, based on the total weight of the composition. In certain examples, the composition may include 0 to 2.5, or 0.5 to 1.75, wt. % CeO₂; 0 to 0.5, or 0.05 to 0.2, wt. % V₂O₅; 0 to 2, or 0.25 to 1, wt. % Er₂O₃; 0 to 1, or 0.05 to 0.65, wt. % Pr₂O₃; 0 to 0.5, or 0.15 to 0.25 wt. % SnO₂; 0 to 0.25, or 0.05 to 0.1 wt. % MnO₂; 0 to 0.5, or 0.05 to 0.15 wt. % F₂; 0 to 4 wt. % Nb₂O₅; 0 to 4 wt. % Ta₂O₅; 0 to 2 wt. % Sm₂O₃; and 0 to 2 wt. % Nd₂O₃, based on the total weight of the composition.

In certain examples, Na₂O, ZrO₂, and TiO₂ are present in the composition in an amount such that Na₂O/(TiO₂+ZrO₂) (wt. %/wt. %) is between 0.5 and 1.25, more particularly 0.65 to 0.9. After undergoing the heat treatment procedures described herein, compositions falling within this ratio range produce a glass-ceramic with Li₂Si₂O₅ as the major crystalline phase, along with Li₂SiO₃ and Li₃PO₄ as the secondary phases. The combination of the phases facilitates the milling and imparts a pleasing translucency to the fully crystallized block.

In certain examples, TiO₂, ZrO₂, SiO₂ and Li₂O are present in the composition in an amount such that ((TiO₂+ZrO₂)/(TiO₂+ZrO₂+SiO₂+Li₂O))×100 (wt. %/wt. %) is between 3.5 and 4, more particularly 3.65 to 3.8. After undergoing the heat treatment procedures described herein, compositions falling within this ratio range produce a glass-ceramic with Li₂Si₂O₅ as the major crystalline phase, along with Li₂SiO₃ and Li₃PO₄ as the secondary phases. The combination of the phases facilitates the milling and imparts a pleasing translucency to the fully crystallized block.

In certain examples, the glass-ceramic comprises 70 to 85 vol. % of a lithium disilicate crystalline phase, 5 to 20 vol. % of a lithium metasilicate crystalline phase, and 2 to 18 vol. % of a lithophosphate crystalline phase, with the percentages being expressed as a portion of the total crystalline phase. In certain examples, the glass-ceramic comprises 72 to 82 vol. % of a lithium disilicate crystalline phase, 7 to 18 vol. % of a lithium metasilicate crystalline phase, and 4 to 14 vol. % of a lithophosphate crystalline phase.

In certain examples, the dental milling blank has a flexural strength (a) greater than 300 MPa, more particularly greater than 400 MPa, and even more particularly greater than 440 MPa.

In certain examples, the dental milling blank has a transmittance of 29 to 34%, or 33 to 37%, or 36 to 40% at 700 nm (when measured on a 2 mm thick fully crystallized glass-ceramic body). The dental milling blank has a pleasing translucency from the gingival to the incisal

In certain examples, the dental milling blank has a fracture toughness (K_{IC}) of greater than 1.5 MPa·m^{1/2}, more particularly greater than 1.65 MPa·m^{1/2}, and even more particularly greater than 1.8 MPa·m^{1/2}.

In certain examples, the dental prosthesis does not require glazing, and can be easily polished to achieve optimum translucency and natural gloss.

The dental milling blank can be produced by a process that includes mixing the initial ingredients, calcining the mixture to convert Li₂CO₃ to Li₂O, K₂CO₃ to K₂O, Na₂CO₃ to Na₂O, Al(OH)₃ to Al₂O₃, and Al(PO₃)₃ to Al₂O₃ and P₂O₅, heating the calcined intermediate to high temperature such that it converts to a homogenous liquid, quenching the liquid to form a glass, and heat treating the quenched glass to form a glass-ceramic.

The initial ingredients include SiO₂, Li₂CO₃, Al(OH)₃, K₂CO₃, Al(PO₃)₃, Na₂CO₃, ZrO₂, and TiO₂. In certain examples, the initial ingredients also include at least one of CeO₂, V₂O₅, Er₂O₃, Pr₂O₃, SnO₂, MnO₂, LiF, Ta₂O₅, Nb₂O₅, Sm₂O₃, or Nd₂O₃. In certain examples, the mixture of initial ingredients includes 53 to 56, or 53.5 to 56, or 54 to 55, wt. % SiO₂; 26.5 to 28.75, or 27 to 28.5, or 27.5 to 28, wt. % Li₂CO₃; 2.75 to 3.17, or 3.00 to 3.17, or 3.05 to 3.17, wt. % Al(OH)₃; 3.2 to 3.6, or 3.45 to 3.55, or 3.48 to 3.5, wt. % K₂CO₃; 2.75 to 3.15, or 3 to 3.1, or 3.02 to 3.05, wt. % Al(PO₃)₃; 2.25 to 4.25, or 3 to 4, or 3.25 to 3.8 wt. % Na₂CO₃; 1.45 to 1.6, or 1.5 to 1.58, or 1.53 to 1.55, wt % ZrO₂; and 0.9 to 1.2, or 0.95 to 1.2, or 0.97 to 1 wt. % TiO₂, based on the total weight of the initial mixture. In certain examples, the mixture of initial ingredients may include 0 to 2, or 0.5 to 1.35, wt. % CeO₂; 0 to 0.3, or 0.05 to 0.15, wt. % V₂O₅; 0 to 1.5, or 0.4 to 0.6, wt. % Er₂O₃; 0 to 0.75, or 0.05 to 0.45, wt. % Pr₂O₃; 0 to 0.2, or 0.17 to 0.18 wt. % SnO₂; 0 to 0.07, or 0.02 to 0.05 wt. % MnO₂; 0 to 0.5, or 0.05 to 0.15 wt. % LiF; 0 to 5 wt. % Nb₂O₅; 0 to 5 wt. % Ta₂O₅; 0 to 3 wt. % Sm₂O₃; and 0 to 3 wt. % Nd₂O₃, based on the total weight of the initial mixture.

The mixing can be accomplished via any manner (e.g, via ball mill).

The calcination involves heating the mixture of initial ingredients. The calcination converts the Li₂CO₃ to Li₂O via the reaction Li₂CO₃→LiO₂+CO₂, converts the K₂CO₃ to K₂O via the reaction K₂CO₃→K₂O+CO₂, converts the Na₂CO₃ to Na₂O via the reaction Na₂CO₃→Na₂O+CO₂, converts the Al(OH)₃ to Al₂O₃ via the reaction Al(OH)₃→Al₂O₃+H₂O, converts the Al(PO₃)₃ to Al₂O₃ via the reaction 2Al(PO₃)₃→Al₂O₃+3P₂O₅. For example, the calcination may involve heating the mixture of initial ingredients at a temperate of 700 to 800° C. for 0.25 to 6 hours.

The calcined mixture is then heated to form a homogeneous liquid. For example, this melting step may involve heating the calcined mixture at a temperature of 1350 to 1600° C. for 1 to 8 hours.

The homogeneous liquid can then be introduced into a mold. The mold may be in the shape of a dental milling blank. The molten mixture is quenched in the mold thereby forming a glass intermediate. In certain examples, the mold is a graphite mold that is preheated at 150 to 450° C. for 0.5 to 2 hours.

The glass intermediate is subsequently heat treated to undergo crystallization. In certain examples, crystallization is a two-step heat-treatment process. The first step involves heating at 620 to 730° C. for 5 to 240 minutes. The second step involves heating at 800 to 875° C. for 2 to 75 minutes. No additional heating of any kind is required after the two-step crystallization.

The resulting product is a millable glass-ceramic dental blank, for example, a millable glass-ceramic dental block.

Dental milling blanks may be formed, for example, as a solid block, disk or near-net-shape, having dimensions suitable for use in milling or grinding single unit or multi-unit restorations, such as crowns, veneers, bridges, partial or full-arch dentures, or a supporting structure such as an implant or an abutment. In certain examples, the dental milling blanks are suitable for use in CAD/CAM.

Subtractive processes, such as milling or machining processes may be used to shape a milling block into a dental restoration. For dental applications, a restoration may include a dental restoration such as a crown, a multi-unit bridge, an inlay or onlay, a veneer, a full or partial denture, or other dental restoration. For example, blocks milled to form dental restorations have anatomical facial surface features including an incisal edge or biting surface, anatomical dental grooves and cusps. In alternative embodiments, lithium disilicate glass-ceramic bodies are shaped into near-net-shape blocks having generic sizes and shapes. The near-net-shape bodies may be prepared having a shape and/or size that is suitable for range of similarly sized and shaped final restoration products.

Dental prostheses may be shaped from glass-ceramic blocks by conventional subtractive processes, such as milling or machining processes known to those skilled in the art. The blocks may be shaped in a crown, a multi-unit bridge, an inlay or onlay, a veneer, a full or partial denture, or other dental prosthesis.

### EXAMPLES

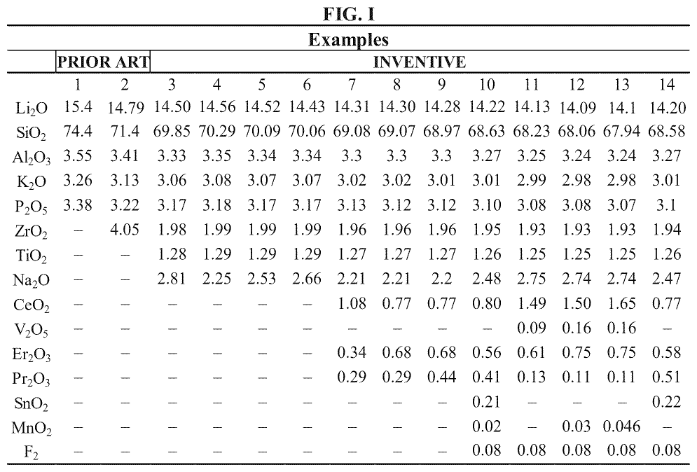

Comparative prior art and illustrative inventive glass compositions are shown in FIG. 1. Comparative prior art (examples 1 and 2), and inventive glass compositions (examples 3-14) outlined in FIG. 1 were synthesized using the processing steps mentioned below:
a) Required amounts of the precursor ingredients (Li₂CO₃, Al(OH)₃, SiO₂ etc.) were weighed and mixed using a jar roller for around 2 hours to obtain a homogenous powder mixture.
b) The powdered mixture was heated at 800° C. for 2 hours to undergo calcination, which converted the precursors to final oxide components listed in FIG. 1.
c) The calcined mixture obtained in step b) was ball milled employing zirconia media to obtain a fine powder.
d) The calcined and homogenized powder was melted in a pure platinum crucible at a temperature of around 1550° C. for a period of 2.5 hours. The high-temperature melt was then poured into graphite molds preheated to 200° C. and cooled down to room temperature to obtain transparent glass blocks.
e) The glass blocks were then subjected to a two-step heat treatment process as outlined below to obtain the final lithium disilicate glass-ceramic:
   Step 1: T₁=700° C. for t₁=20 minutes
   Step 2: T₂=840° C. for t₂=10 minutes
      Table I below reports the identified crystalline phases (vol %), transmittance at 700 mm, fracture toughness, and biaxial flexural strength of examples 10-14.

TABLE I
Properties of Examples in FIG. 1

| Example | 10 | 11 | 12 | 13 | 14 |
|---|---|---|---|---|---|
| vol. % of crystalline phases: | | | | | |
| Li₂SiO₅ | 77.90 | 75.45 | 78.80 | 78.80 | 78.60 |
| Li₂SiO₃ | 14.00 | 16.15 | 13.10 | 15.74 | 10.14 |
| Li₃PO₄ | 8.10 | 8.40 | 8.10 | 5.50 | 11.40 |
| Transmittance at 700 nm | 36.5 | 34.23 | 34.17 | 33.21 | 36.28 |
| Fracture Toughness | 1.83 | 1.9 | 1.88 | 1.9 | 1.89 |
| (MPa · m^{1/2}) | | | | | |
| Biaxial Flexural Strength | 511 | 447 | 471 | 463 | 486 |
| (MPa) (ISO 6872) | | | | | |

### X-Ray Diffraction

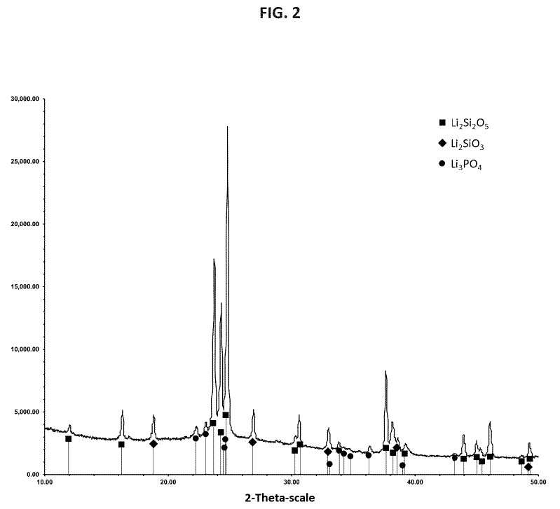

X-ray diffraction (XRD) analysis was conducted on bulk glass-ceramic samples to identify the crystalline phases. The measurements were performed on Rigaku Ultima-III X-ray Diffractometer with Cu K_{α} radiation and Bragg-Brentano geometry. Identification of crystalline phases was carried out utilizing the International Center for Diffraction Data (ICDD) database, and quantitative analysis (vol. % of phases) was performed using the Reference Intensity Ratio (RIR) method. An illustrative X-ray diffraction pattern is shown in FIG. 2.

### Fracture Toughness

Fracture toughness of the glass-ceramic samples was estimated by the crack lengths produced via a Vickers Indenter under an applied load of 19.61 N. Rectangular glass-ceramic tabs with a thickness of about 10 mm were single-side polished to ensure a scratch free surface for testing. The polishing process was carried out as per the guidelines outlined in Table II.

Vickers indents were applied using a Shimadzu Mirco Hardness Tester (HMV-G21), and the crack lengths resulting from the indentation were measured using the built-in optical microscope. These measurements, along with the measured length of the indentation diagonal, were then utilized to calculate fracture toughness using the method detailed by B. R. Lawn (J. Mater. Sci., 10(6) P1049-1081, 1980) and G. R. Anstis (J. Am. Ceram. Soc., 64(9), P533-538, 1981) via the equation:

$${K}_{IC} = 0.0 \; 205 \times [ 2 \sqrt{( E / H )} ] \times [ P / ( 3 / 2 \sqrt{C} ) ]$$

### Where:

K_{IC}: Fracture toughness (MPa·m^{1/2})
E: Young's modulus (GPa)=95 GPa
H: Vickers hardness (GPa)*
P: applied load (19.61 N)
C: crack length from the center of the impression to the crack tip (m)
   The Vickers hardness (H) was calculated using the formula:

$$H = 1.8 \; 54 \times ( P / {d}^{2} )$$

### Where:

P: applied load (19.61 N)
d: Length of the indentation diagonal (m)
   Hardness testing was performed according to the procedure outlined in G. F. Vander Voort, Microindentation Hardness Testing, Mechanical Testing and Evaluation, Vol 8, ASM Handbook, Edited by H. Kuhn, D. Medlin, ASM International, 2000, p221-231.

TABLE II
Grinding and Polishing procedure for Vickers Indentation
Grinding
Media-Diamond; Solution-water
Step 1: 200 μm; Step 2: 68 μm; Step 3: 30 μm; Step 4: 15 μm
Polishing
Media: Polycrystalline Diamond Suspension
Step 1: 15 μm; Step 2: 3 μm; Step 3: 1 μm
Final Polishing
0.6 μm Silica suspension; Solution-water

### Transmittance at 700 nm

Transmittance spectra were acquired on glass-ceramic samples measuring approximately 2±0.1 mm in thickness and having a surface area of about 165 mm². Before testing, samples were hand polished on both sides using the guidelines outlined in Table III. Measurements were conducted on a Konika Minolta CM-5 spectrophotometer using a customized fixture with an 8 mm aperture. Measurement geometry was diffuse illumination, and zero-degree observation (d: 0°). Values reported in Table I correspond to % transmittance at 700 nm for the samples.

TABLE III
Grinding and Polishing procedure for transmittance experiments
Grinding
Media-Diamond; Solution-water
Step 1: 200 μm; Step 2: 68 μm; Step 3: 30 μm; Step 4: 15 μm
Polishing
15 μm Polycrystalline Diamond Suspension

### Flexural Strength

Cylindrical glass rods with a diameter of 14±2 mm were cast and converted to glass-ceramics using the 2-step heat treatment protocol outlined in Examples section (e). Discs were cut from the glass-ceramic rods using a precision saw and were grinded and polished on both sides to obtain test specimen with a thickness of 1.2±0.2 mm and a diameter of 14±2 mm. The grinding and polishing procedure is described in Table IV. Flexural strength was measured on a Shimadzu EZ-LX Universal Electromechanical Test Frame utilizing a custom biaxial fixture (piston-on-three ball test) designed in accordance with the guidelines outlined in ISO 6872:2015 (E) Dentistry—Ceramic Materials. Table I reports the biaxial flexural strength for the samples.

TABLE IV
Grinding and Polishing procedure for Flexural Strength
Grinding
Media-Diamond; Solution-water
Step 1: 200 μm; Step 2: 30-40 μm
Polishing
15-20 μm Polycrystalline Diamond Suspension

In view of the many possible embodiments to which the principles of the disclosed invention may be applied, it should be recognized that the illustrated embodiments are only preferred examples of the invention and should not be taken as limiting the scope of the invention.

What is claimed is:

1. A lithium disilicate glass-ceramic produced from a composition comprising SiO₂, Li₂O, Al₂O₃, K₂O, P₂O₅, Na₂O, ZrO₂, and TiO₂, wherein Na₂O, ZrO₂, and TiO₂ are present in the composition in an amount such that Na₂O/(TiO₂+ZrO₂) (wt. %/wt. %) is between 0.5 and 1.25.

2. The glass-ceramic of claim 1, wherein Na₂O/(TiO₂+ZrO₂) (wt. %/wt. %) is between 0.65 and 0.9.

3. The glass-ceramic of claim 1, wherein TiO₂, ZrO₂, SiO₂ and Li₂O are present in the composition in an amount such that ((TiO₂+ZrO₂)/(TiO₂+ZrO₂+SiO₂+Li₂O))×100 (wt. %/wt. %) is between 3.5 and 4.

4. The glass-ceramic of claim 3, comprising 70 to 85 vol. % of a lithium disilicate crystalline phase, 5 to 20 vol. % of a lithium metasilicate crystalline phase, and 2 to 18 vol. % of a lithophosphate crystalline phase, with the percentages being expressed as a portion of a total crystalline phase of the glass-ceramic.

5. The glass-ceramic of claim 1, wherein the composition comprises 65 to 71 wt. % SiO₂, 12.5 to 14.75 wt. % Li₂O, 2.80 to 3.40 wt. % Al₂O₃, 2.75 to 3.10 wt. % K₂O, 2.80 to 3.20 wt. % P₂O₅, 1.50 to 3.50 wt. % Na₂O, 1.5 to 2.5 wt. % ZrO₂, and 1.2 to 1.5 wt. % TiO₂, based on the total weight of the composition.

6. The glass-ceramic of claim 1, wherein the composition further comprises one or more of CeO₂, V₂O₅, Er₂O₃, Pr₂O₃, SnO₂, MnO₂, or F₂.

7. A dental milling blank comprising the glass-ceramic of claim 1.

8. The dental milling blank of claim 7, wherein the dental milling blank has a flexural strength greater than 300 MPa.

9. The dental milling blank of claim 7, wherein the dental milling blank has a flexural strength greater than 440 MPa.

10. The dental milling blank of claim 1, wherein the dental milling blank has a transmittance of 29 to 40% at 700 nm (when measured on a 2 mm thick fully crystallized glass-ceramic body).

11. The dental milling blank of claim 7, wherein the dental milling blank has a fracture toughness of greater than 1.6 MPa·m^{1/2}.

12. A lithium disilicate glass-ceramic produced from a composition comprising SiO₂, Li₂O, Al₂O₃, K₂O, P₂O₅, Na₂O, ZrO₂, and TiO₂, wherein TiO₂, ZrO₂, SiO₂ and Li₂O are present in the composition in an amount such that ((TiO₂+ZrO₂)/(TiO₂+ZrO₂+SiO₂+Li₂O))×100 (wt. %/wt. %) is between 3.5 and 4.

13. The glass-ceramic of claim 12, wherein ((TiO₂+ZrO₂)/(TiO₂+ZrO₂+SiO₂+Li₂))×100 (wt. %/wt. %) is between 3.65 and 3.8.

14. The glass-ceramic of claim 12, comprising 70 to 85 vol. % of a lithium disilicate crystalline phase, 5 to 20 vol. % of a lithium metasilicate crystalline phase, and 2 to 18 vol. % of a lithophosphate crystalline phase, with the percentages being expressed as a portion of a total crystalline phase of the glass-ceramic.

15. The glass-ceramic of any claim 12, wherein the composition comprises 65 to 71 wt. % SiO₂, 12.5 to 14.75 wt. % Li₂O, 2.80 to 3.40 wt. % Al₂O₃, 2.75 to 3.10 wt. % K₂O, 2.80 to 3.20 wt. % P₂O₅, 1.50 to 3.50 wt. % Na₂O, 1.5 to 2.5 wt. % ZrO₂, and 1.2 to 1.5 wt. % TiO₂, based on the total weight of the composition.

16. The glass-ceramic of claim 12, wherein the composition further comprises one or more of CeO₂, V₂O₅, Er₂O₃, Pr₂O₃, SnO₂, MnO₂, or F₂.

17. A dental milling blank comprising the glass-ceramic of claim 12.

18. The dental milling blank of claim 17, wherein the dental milling blank has a flexural strength greater than 300 MPa.

19. The dental milling blank of claim 17, wherein the dental milling blank has a flexural strength greater than 440 MPa.

20. The dental milling blank of claim 17, wherein the dental milling blank has a transmittance of 29 to 40% at 700 nm (when measured on a 2 mm thick fully crystallized glass-ceramic body).

21. The dental milling blank of claim 17, wherein the dental milling blank has a fracture toughness of greater than 1.6 MPa·m^{1/2}.

22. A glass-ceramic comprising 70 to 85 vol. % of a lithium disilicate crystalline phase, 5 to 20 vol. % of a lithium metasilicate crystalline phase, and 2 to 18 vol. % of a lithophosphate crystalline phase, with the percentages being expressed as a portion of a total crystalline phase of the glass-ceramic.
